(19) United States
(12) Patent Application Publication
(10) Pub. No.: US 2020/0179734 A1
(43) Pub. Date: Jun. 11, 2020

(54) PRESSURIZED FIRE EXTINGUISHING APPARATUSES FOR USE IN FIGHTING FOREST FIRES AND RELATED METHODS

(71) Applicant: EMMANUEL JACKSON, Taylors, SC (US)

(72) Inventor: EMMANUEL JACKSON, Taylors, SC (US)

(21) Appl. No.: 16/707,328

(22) Filed: Dec. 9, 2019

Related U.S. Application Data
(60) Provisional application No. 62/776,840, filed on Dec. 7, 2018.

(51) Int. Cl. A62C 3/02; A62C 27/00

(52) U.S. Cl. CPC A62C 3/0242; A62C 27/00

(57) ABSTRACT

Fire extinguishing apparatuses for use in fighting forest fires and related methods are disclosed herein. In particular, pressurized fire extinguishing and suppression apparatuses for use in fighting forest fires and prevention of damage and destruction to homes and other structure are provided that can dispense a spray of liquid, such as water, in a 360° radius. Methods related to the manufacture and use of the fire extinguishing apparatuses disclosed herein are also provided.

### RELATED APPLICATION

The presently disclosed subject matter claims the benefit of U.S. Provisional Patent Application Ser. No. 62/776,840, filed Dec. 7, 2018, the disclosure of which is incorporated herein by reference in its entirety.

### TECHNICAL FIELD

The present subject matter relates to pressurized fire extinguishing apparatuses and related methods, in particular, the present subject matter relates to pressurized fire extinguishing apparatuses for use in fighting forest fires that can provide a spray of liquid, such as water, in a 360° radius and related methods.

### BACKGROUND

Wild fires are a common problem in the United States, particularly out west in such states as Colorado, New Mexico, Oregon, Idaho, Nevada, and California. Since the turn of the 20th century, various federal and state agencies have been involved in wildland fire management in one form or another. In the early 20th century, for example, the federal government, through the U.S. Army and the U.S. Forest Service, solicited fire suppression as a primary goal of managing the nation's forests. At this time in history fire was viewed as a threat to timber, an economically important natural resource. As such, the decision was made to devote public funds to fire suppression and fire prevention efforts. Beginning in the 1970s public perception of wildland fire management began to shift. Despite strong funding for fire suppression in the first half of the 20th century, massive wildfires continued to be prevalent across the landscape of North America. Ecologists were beginning to recognize the presence and ecological importance of natural, lightning-ignited wildfires across the United States. It was learned that suppression of fire in certain ecosystems may in fact increase the likelihood that a wildfire will occur and may increase the intensity of those wildfires With the emergence of fire ecology as a science also came an effort to apply fire to ecosystems in a controlled manner; however, suppression is still the main tactic when a fire is set by a human or if it threatens life or property. By the 1980s, in light of this new understanding, funding efforts began to support prescribed burning in order to prevent wildfire events. In 2001, the United States implemented a National Fire Plan, increasing the budget for the reduction of hazardous fuels from $108 million in 2000 to $401 million.

Weather cycles and climate change both play a big role in shaping wildfires. It is speculated that climate change may be affecting long-term trends with hotter weather, longer growing seasons and even stronger winds that help feed the flames. During the first 40 years of record keeping, between 1960 and 1999. wildfires destroyed nearly 141 million acres of land in the United States. Between 2000 and 2013, nearly 161 million acres were consumed by wildfires—more in 13 years than in the previous 40 years, combined. Changes in Forest Service policy and an increase in the number of American homes built in or near wild lands offer insight into this upward trend in wildfire occurrence and damage.

The U.S. Forest Service responds to all wildfires detected on National Forests and Grasslands, regardless of how they start. The U.S. Forest Service is well prepared to respond to wildfires safely and effectively, with more than 10,000 firefighters, 900 engines, and hundreds of aircraft available. Planes and helicopters are critical tools in managing wildland fire. In addition to providing reconnaissance of new fires, fire locations, and fire behavior supplying firefighter with supplies, such aircraft can drop fire retardant or water to slow down a fire so firefighters can contain it. However, the fire retardant and water drops are not always that effective. They are hard to control the direction and flow of the drop and can often end in the water drop not being as effective at suppressing and/or extinguishing the fire.

Additionally, the areas where wildfires are most common have been growing in population over the past 70 years. There's been an enormous increase in the number of people at risk from wildfire in the western US in recent decades. The population in wildfire-prone areas, such as certain areas in the states of California, Washington, Oregon, Idaho and Nevada has exploded since 1940. when just 607,000 houses were in locations threatened by wildfires. The at-risk number of properties in the western US has grown since that time by more than 1,000%, according to recent research with an estimated 6.7 million homes now at significant risk from fires that are getting larger and more frequent. Thus, a need for providing methods and apparatuses that can better protect homes and other structures in populated areas has arisen.

As such, a need exists for improved wildfire extinguishment and suppression as well as methods and apparatuses for protect homes and other structures in populated areas where wildfires occur.

### SUMMARY

The present subject matter provides fire extinguishing and suppression apparatuses and related methods. In particular, pressurized fire extinguishing and suppression apparatuses for use in fighting forest fires and prevention of damage and destruction to homes and other structure are provided that can dispense a spray of liquid, such as water, in a 360° radius. Methods related to the manufacture and use of the fire extinguishing apparatuses disclosed herein are also provided.

Thus, it is an object of the presently disclosed subject matter to provide fire extinguishing and suppression apparatuses and related methods. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIGS. 1A and 1B illustrate perspective views of embodiments of a fire extinguishing apparatus being used with different helicopters to extinguish wildfires according to the present subject matter;

FIG. 1C illustrates a perspective view of an embodiment of a fire extinguishing apparatus for use with a helicopter to extinguish wildfires according to the present subject matter;

FIG. 1D illustrates a top plan view of an embodiment of a differential gear that can be used with the fire extinguishing apparatus according to FIG. 1C;

FIG. 2 illustrates a vertical cross-sectional view of an embodiment of a holding tank and dispenser container of the fire extinguishing apparatus according to FIG. 1C;

FIG. 3 illustrates a perspective view of another embodiment of a fire extinguishing apparatus for use with a helicopter to extinguish wildfires according to the present subject matter;

FIG. 4A illustrates a side view of a bottom of the embodiment of the holding tank of the fire extinguishing apparatus according to FIG. 1C with a door in an open position;

FIG. 4B illustrates a bottom plan view of the embodiment of the holding tank of the fire extinguishing apparatus according to FIG. 4A with a door in a closed position;

FIG. 5A illustrates a bottom plan view of an embodiment of a holding tank of a fire extinguishing apparatus according to the present subject matter with a door in an open position;

FIG. 5B illustrates a bottom plan view of the embodiment of the holding tank of the fire extinguishing apparatus according to FIG. 5A with the door in a closed position;

FIG. 6B illustrates a perspective view of another embodiment of a fire extinguishing apparatus for use with a helicopter to extinguish wildfires according to the present subject matter;

FIG. 7 illustrates a perspective view of an embodiment of a movable fire extinguishing apparatus for use on a ground level track to extinguish wildfires according to the present subject matter;

FIG. 8 illustrates a perspective view of the embodiment of the movable fire extinguishing apparatus according to FIG. 7;

FIG. 9 illustrates a vertical cross-sectional view of an embodiment of a drive system of the movable fire extinguishing apparatus according to FIG. 7;

FIG. 10 illustrates a vertical cross-sectional view of an embodiment of a holding tank and dispenser container of the movable fire extinguishing apparatus according to FIG. 7; and

FIG. 11 illustrates a perspective view of an embodiment of a fire extinguishing apparatus to be dropped from an aerial vehicle to extinguish wildfires according to the present subject matter;

Repeat use of reference characters in the present specification and drawings is intended to represent the same or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. Thus, it is intended that the present subject matter cover such modifications and variations as come within the scope of the appended claims and their equivalents. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer or section. Thus, a first feature, element, component, region, layer or section discussed below could be termed a second feature, element, component, region, layer or section without departing from the teachings of the disclosure herein.

Similarly, when a layer or coating is being described in the present disclosure as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted or simplified to facilitate explanation of the subject matter disclosed herein. Thus, the features, elements or components illustrated in the figures are schematic in nature and their shapes and/or positions are not intended to illustrate the precise configuration of the subject matter and are not intended to limit the scope of the subject matter disclosed herein.

It is to be understood that the ranges and limits mentioned herein include all ranges located within the prescribed limits (i.e., subranges). For instance, a range from about 100 to about 200 also includes ranges from 110 to 150.170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5 as examples.

As disclosed herein fire extinguishing and suppression apparatuses are provided that hold suppressing liquid, such as water, expel the suppressing liquid under high air pressure to extinguish flames and embers upon contact of the suppressing liquid with burning timber or other burning or smoldering fuel. For example, a fire extinguishing and suppression apparatus can be provided that can be transported by and operated from a helicopter. The fire extinguishing and suppression apparatus helicopter unit can comprise a holding tank configured to hold water and that can have a plurality of compressed air tanks therein.

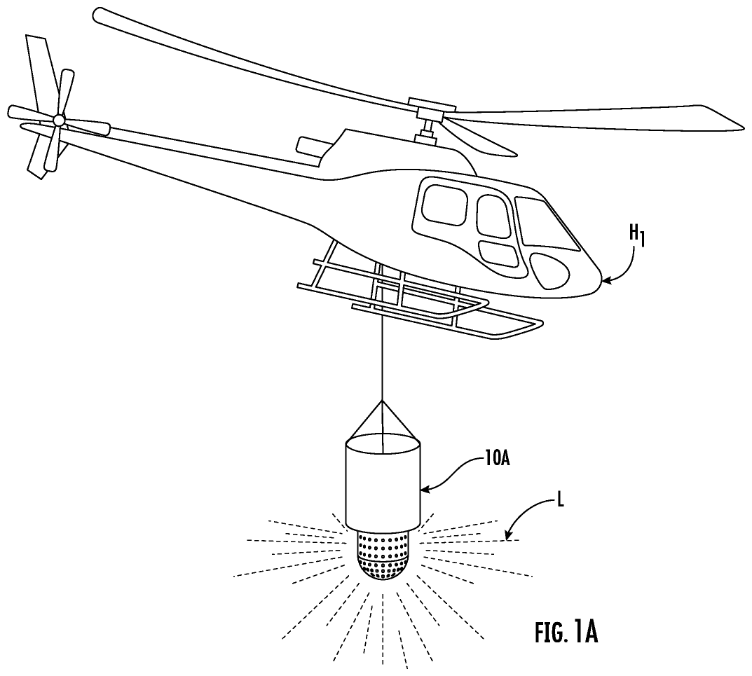

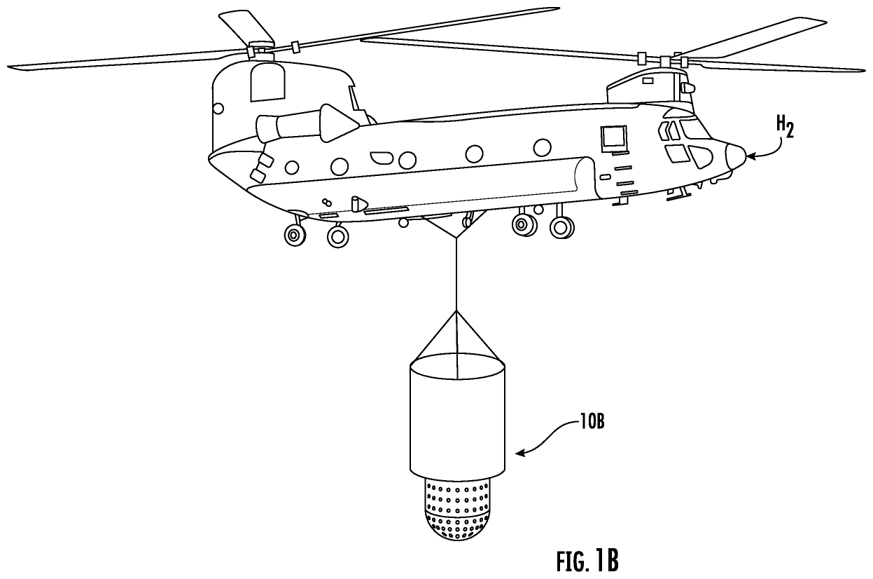

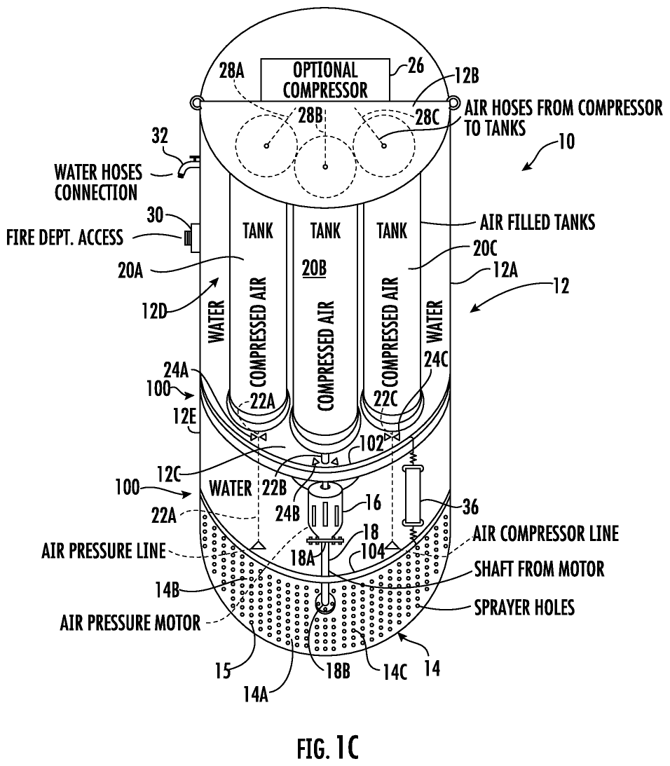

Fire extinguishing apparatuses for use with a helicopter to extinguish wildfires are provided in FIGS. 1A-6B. As shown in FIG. 1A, a fire extinguishing apparatus, generally designated 10A, can be suspend from an undercarriage of a fuselage of a single-rotor helicopter H₁ and can be airlifted by the helicopter H₁ to forested areas were a wild fire is occurring. Water or other liquid L can then be forcibly dispersed from the fire extinguishing apparatus 10A onto the wildfire. Similarly, as shown in FIG. 1B, a larger fire extinguishing apparatus, generally designated 10B can be suspended from an undercarriage of a fuselage of a multi-rotor helicopter H₂, such as a CH-47 Chinook helicopter manufactured by the Boeing Company based in Chicago, Ill., or the Mil V-12 manufactured in Russia, to be used to disperse water or liquid on to fires in a similar manner. The fire extinguishing apparatuses 10A, 10B can vary in size depending on the amount of liquid to be carried and the amount of weight that the helicopter can carry. For example, the fire extinguishing apparatuses 10A, 10B can hold between about 500 gallons to about 10,000 gallons. In some embodiments the fire extinguishing apparatuses 10A, 10B can hold about 500 gallons. In some embodiments, the fire extinguishing apparatuses 10A, 10B can hold about 2,000 gallons. In some embodiments, the fire extinguishing apparatuses 10A, 10B can hold about 5,000 gallons. In some embodiments, the fire extinguishing apparatuses 10A, 10B can hold about 10,000 gallons.

More particularly, as shown in more detail in FIGS. 1C-5B, a fire extinguishing apparatus, generally designated 10, illustrated in FIG. 1C can comprise a holding tank 12 having a cylindrical body 12A, a top 12B and a bottom 12C that defines a cavity 12D that is configured to hold water. The fire extinguishing apparatus 10 can also comprise a plurality of compressed air tanks 20A, 20B, 20C positioned within the cavity 12D of the holding tank 12 with each compressed air tank 20A, 20B, 20C having a conduit 22A, 22B, 22C passing from the corresponding tank 20A, 20B, 20C through the bottom 12C of the holding tank 12. The tanks 20A, 20B, 20C, for example, can contain compressed air under between about 5,000 p.s.i. and about 30,000 p.s.i. The fire extinguishing apparatus 10 can also comprise a valve 24A, 24B, 24C positioned on each conduit 22A, 22B, 22C within the holding tank 12 proximate to the bottom 12C of the holding tank 12. Further, the fire extinguishing apparatus 10 can comprise a dispenser container 14 rotatably attached the holding tank 12. The dispenser container 14 can have a bottom 14A and walls 14B that extend upward from the bottom 14A with at least a section 14C of the walls 14B and the bottom 14A being perforated with perforation holes 15. For example, in some embodiments, the dispenser container 14 can have a cylindrical body and a bottom. In some embodiments, the dispenser container 14 can have walls that form a portion of a spherical globe shape. The perforation holes 15 can extend through the walls of the dispenser container 14 at an angle to facilitate the rotation of the dispenser container 14 when put under pressure by the compressed air tanks 20A, 20B, 20C.

The fire extinguishing apparatus 10 can additionally comprise a pressure operated motor 16 secured to an under surface of the bottom 12C of the holding tank 12. The motor 16 can be connected to one of the conduits 22A, 22B, 22C of one of the compressed air tanks 20A, 20B, 20C to supply the motor 16 with pressurized air to operate the motor 16. For example, as shown in FIG. 1C, the motor 16 can be connected to the conduit 22 of the compressed air tank 20B. A shaft 18 can be rotatably secured to the motor 16 at a first end 18A and a secured to the dispenser container 14 at a second end 18B. Thus, as the motor 16 spins the shaft 18, the motor 16 rotates the dispenser container 14 to dispense water from the dispenser container 14. The compressed air tanks 20A, 20B, 20C can be secured in the holding tank 12 so that the compressed air tanks 20A, 20B, 20C are held stable as the dispenser container 14 rotates. In some embodiments, instead of a shaft that engages the bottom of the dispenser container 14, the shaft of the motor 16 can drive a differential gear 19 to rotate the dispenser container 14 as shown in FIG. 1D, or can drive a pulley system that rotates or spins the dispenser container 14.

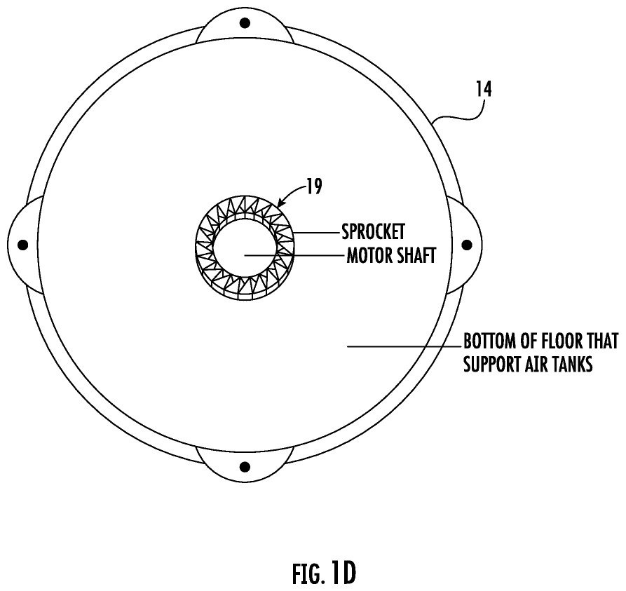

To hold the dispenser container 14 to the holding tank 12, the dispenser container 14 can be secured to the holding tank 12 by an engagement 100. In some embodiments, the engagement 100 can compose one or more support rails. In some embodiments, the engagement 100 can comprise at least one race and bearing assembly. The engagement 100, such as one or more support rails and/or one or more bearing assemblies, can include rubber seals to aid in water or liquid containment For example, as shown in FIGS. 1C and 2, the dispenser container 14 can be secured to the holding tank 12 by an engagement 100 comprising a first race and bearing assembly 102 and a second race and bearing assembly 104. The first race and bearing assembly 102 can comprise a first race 102A and a set of bearings 106 that can engage the first race 102A. The second race and bearing assembly 104 can comprise a second race 104A and a set of bearings 108 that can engage the second race 104A. The upper first race 102A and a lower second race 104A can be secured to the holding tank 12 and the upper set of bearings 106 can be secured to the dispenser container 14 in a position to engage the upper first race 102A and the lower set of bearings 108 can be secured to the dispenser container 14 in a position to engage the lower second race 104A.

In particular, in some embodiments as shown in FIG. 2, the holding tank 12 can further comprise cylindrical side walls 12E that extend downward from the bottom 12C of the holding tank 12 and the walls 14B of dispenser container 14 can comprise cylindrical side walls that extend upward from the section 14C that includes the perforations 15. The holding tank cylindrical side walls 12E can form an outer shell OS₁ having the upper first race 102A secured thereto proximate the bottom 12C of the holding tank and the lower race 104A secure to the holding tank side walls 12E near a distal end of the outer shell OS₁. The dispenser container side walls 14B forming an inner shell IS₁ that can have bearings 106, 108 secured thereto for engaging the upper first race 102A and the lower second race 104A respectively to form the engagement 100.

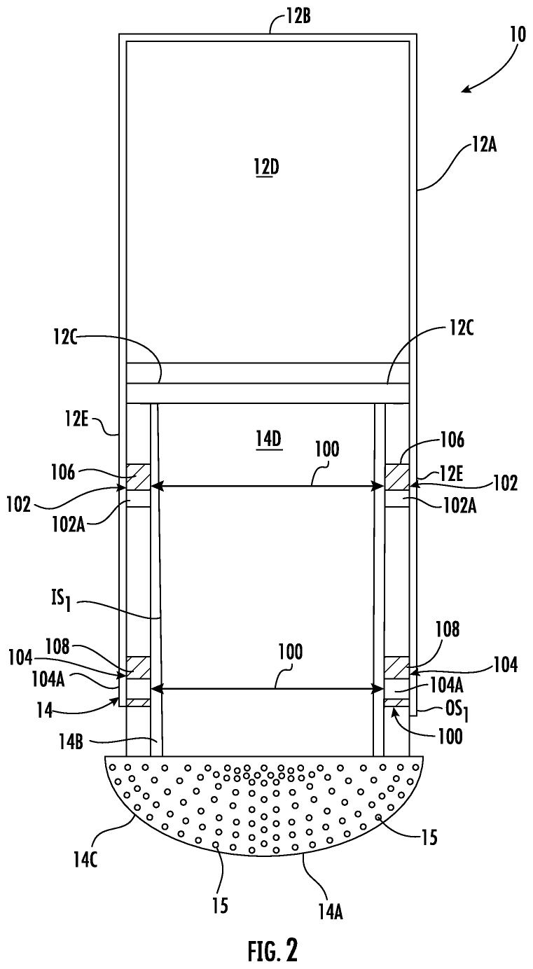

In some embodiments when needed or desired, the fire extinguishing apparatus 10 can further comprise an air compressor 26 secured to the holding tank 12 as shown in FIGS. 1C and 3. The air compressor 26 can have a plurality of air lines 28A, 28B, 28C that provide air from the air compressor 26 to the respective compressed air tanks 20A, 20B, 20C. In some such embodiments, the air compressor 26 can be secured to the top 12B of the holding tank 12.

To supply water to the holding tank 12, some embodiments of the fire extinguishing apparatus 10 can comprise a fire department access nozzle 30 that is configured to the holding tank 12. The fire department access nozzle 30 can be closed off with a cap that can be removed to allow a fire hose to screw onto or attach to the fire department access nozzle 30. Similarly, some embodiments of Fire extinguishing apparatus 10 can comprise a valve 32 engaging the holding tank 12 for connecting a common water hose to provide water to the holding tank 12.

In some embodiments of the fire extinguishing apparatus 10 as shown in FIG. 3, a rudder 34 can be secured to a side of the holding tank 12 to steady the holding tank 12 upon operation of the motor to spin the dispenser container while hanging from a helicopter. The rudder 34 can be attached to the holding tank 12 by a support bracket 33. In some embodiments, the rudder 34 can be controlled through wired or wireless communication from the cockpit of the helicopter or from some other remote control within the helicopter. As shown in FIG. 3, the fire extinguishing apparatus 10 can also comprise hanging lines HL that are used to suspend the fire extinguishing apparatus 10 from the helicopter. The hanging lines HL can comprise heavy duty chains or heavy duty lifting sling material that can bear the weight and forces involved in lifting and operating various sized fire extinguishing apparatuses 10. In some embodiments as shown in FIG. 1C, one or more spring loaded shock absorbers 36 secured to the holding container 12 and a portion of the dispenser container 14 that does not rotate with the dispenser container 14.

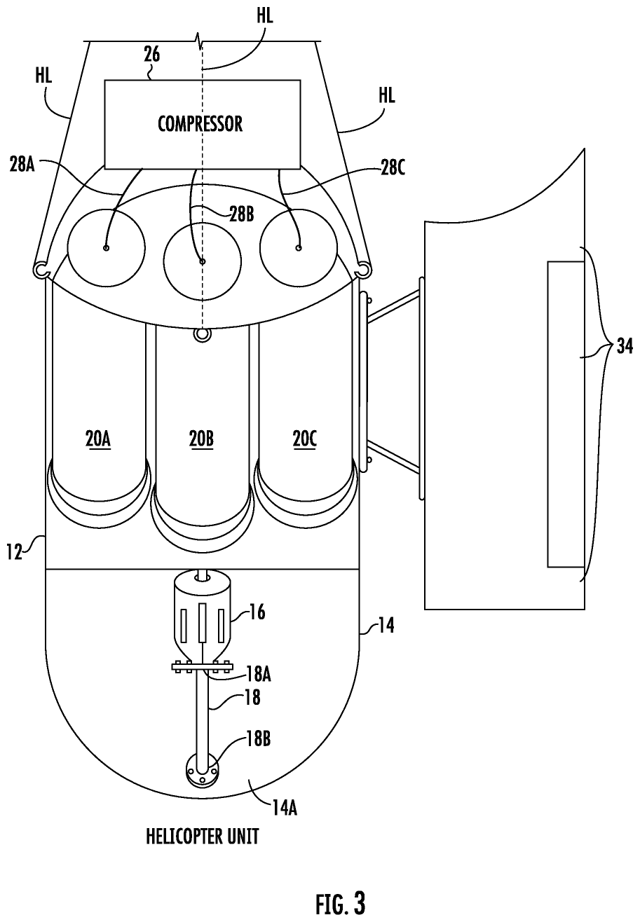

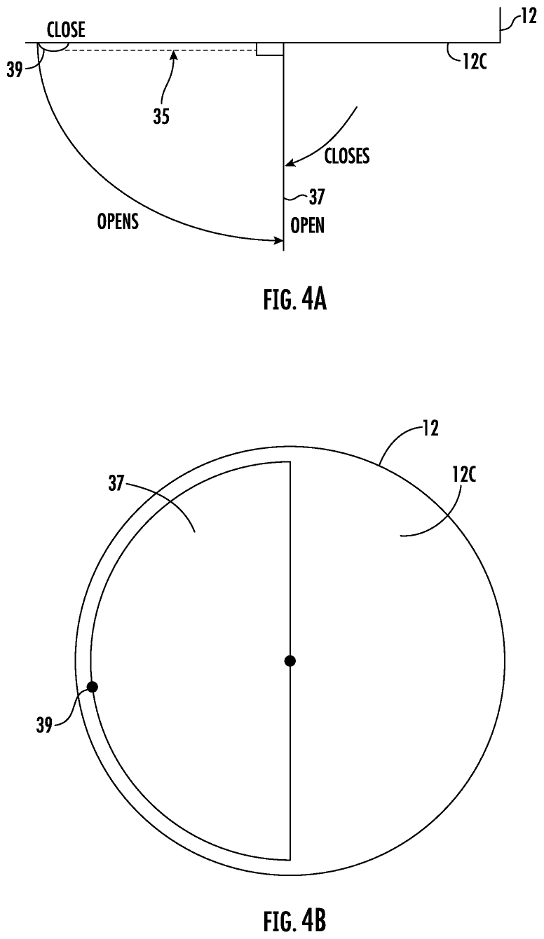

To transfer the water from the holding tank 12 to the dispenser container 14, the holding tank 12 can have an opening 35 within the bottom 12C of the holding tank 12 with a door 37 that opens and closes as shown in FIGS. 4A and 4B to allow water to transfer from the holding tank 12 to the dispenser container 14. In particular, the door 37 can be secured by a hinge to the bottom 12C of the container on one side and held in a closed position by a latch 39 on the other side. The latch 39 can be released allowing the door 37 to drop down to quickly allow liquid to pass through the opening 35 into the dispenser container 14. For example, the latch 39 can be released through wired or wireless communication mechanism from the cockpit of the helicopter to allow the door 37 to open under gravity.

The opening 35 and the door 37 can be of a size that allows the door 37 to rotatably open and close without interfering with the conduits 22A, 22B, 22C of one of the air compressed tanks 20A, 20B, 20C that pass through the bottom 12C of the holding tank 12 and the motor and the motor 16 connection on the bottom 12C of the holding tank 12. In some embodiments, the opening 35 can cover approximately almost half the bottom 12C of the holding tank 12. In some embodiments, the opening 35 can cover less than half the bottom 12C of the holding tank 12. As the door 37 opens, water in the holding tank 12 pass through the opening 35 in the bottom 12C of the holding tank 12 into the dispenser container 14 and the valves 24A, 24B, 24C positioned on each conduit 22A, 22B, 22C can be opened to respectively operate the motor 16 to spin the dispenser container 14 and provide compressed air to the internal cavity 14D of the dispenser container 14 to force the water from the holding tank 12 out of the perforations 15 in the perforated section 14C of the dispenser container 14. The door 37 can be controlled by a controller to release the latch 39 from within the cockpit of the helicopter. For example, the controller can include a computer device that can be in communication with at least one of a solenoid valve or a pressure valve to release the latch 39 and open the door 37.

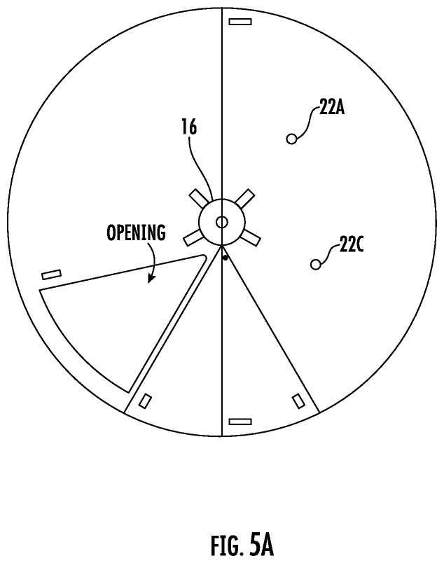

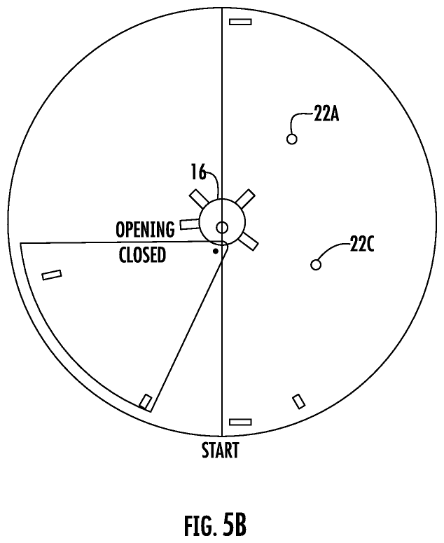

Alternatively, to transfer the water from the holding tank 12 to the dispenser container 14, the holding tank can have an opening 35 therein with a rotatable door 38 that opens and closes as shown in FIGS. 5A and 5B to allow water to transfer from the holding tank 12 to the dispenser container 14. The opening 35 and the rotatable door 38 are of a size that allows the door 38 to rotatably open and close without interfering with the conduits 22A, 22B, 22C of one of the air compressed tanks 20A, 20B, 20C that pass through the bottom 12C of the holding tank 12 and the motor and the motor connection on the bottom 12C of the holding tank 12. As the door 38, opens, water in the holding tank 12 pass through the opening 35 in the bottom 12C of the holding tank 12 into the dispenser container 14 and the valves 24A, 24B, 24C positioned on each conduit 22A, 22B, 22C can be opened to respectively operate the motor 16 to spin the dispenser container 14 and provide compressed air to the internal cavity 14D of the dispenser container 14 to force the water from the holding tank 12 out of the perforations 15 in the perforated section 14C of the dispenser container 14. The door 38 can be controlled by a controller to open and close the door 38. For example, the controller can include a computer device that can be in communication with at least one of a solenoid valve or a pressure valve to open and close the door 38.

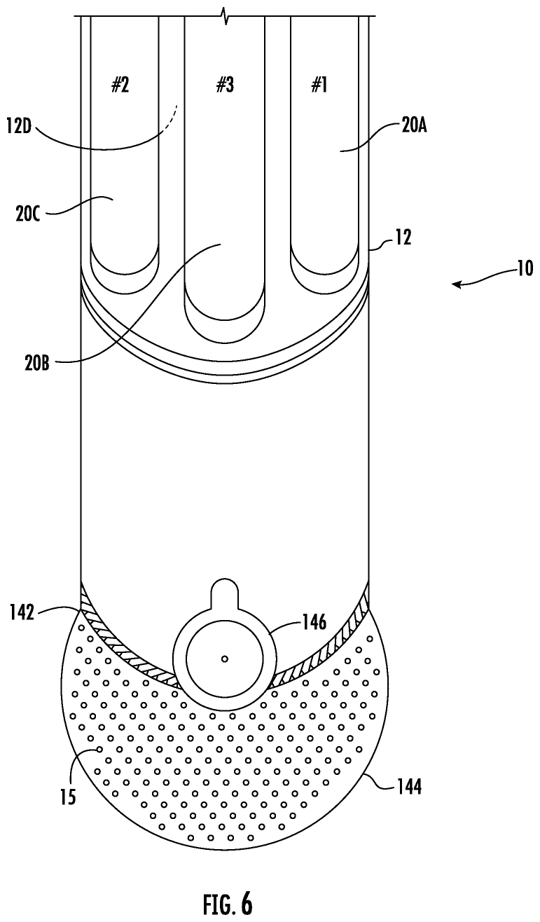

FIG. 6 shows a similar embodiment of a fire extinguishing apparatus, generally designated 10, that can comprise a holding tank 12 similar to the holding tanks described above that defines a cavity 12D that is configured to hold water and a plurality of compressed air tanks 20A, 20B, 20C positioned within the cavity 12D of the holding tank 12 that have conduits and operate similarly to the air tanks 20A, 20B, 20C described above, but with all the tanks configured to dispense compressed air into a dispenser container 144 having perforation holes 15. Further, the fire extinguishing apparatus 10 can comprise an electric motor 146 that engages a differential gear 142 integral to the dispenser container 144 such that the dispenser container 144 is rotatably attached the holding tank 12. The electric motor 146 can be secured to the outside of the holding tank 12 and can drivingly rotate the dispenser container 144 when the fire extinguisher 10 is dispensing water or liquid. As shown, the dispenser container 144 can have walls that form a portion of a spherical globe shape. In some embodiments, the electric motor 146 with the differential gear 142 can be use in addition to a pressure operate motor 16 as shown above. For example, in some such embodiments, the electric motor 16 can be used as a back up to the pressure operate motor 16 in case of motor failure, or in instances were more power is needed.

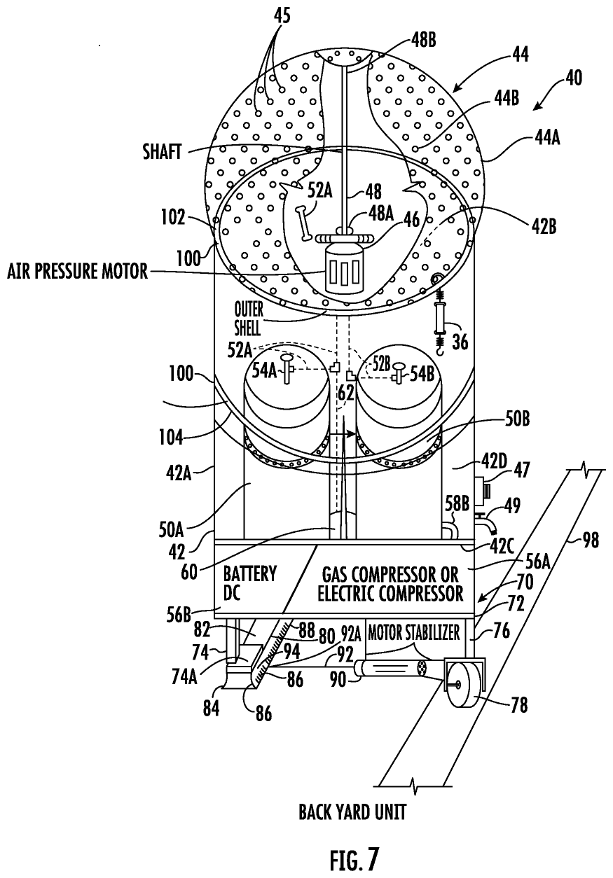

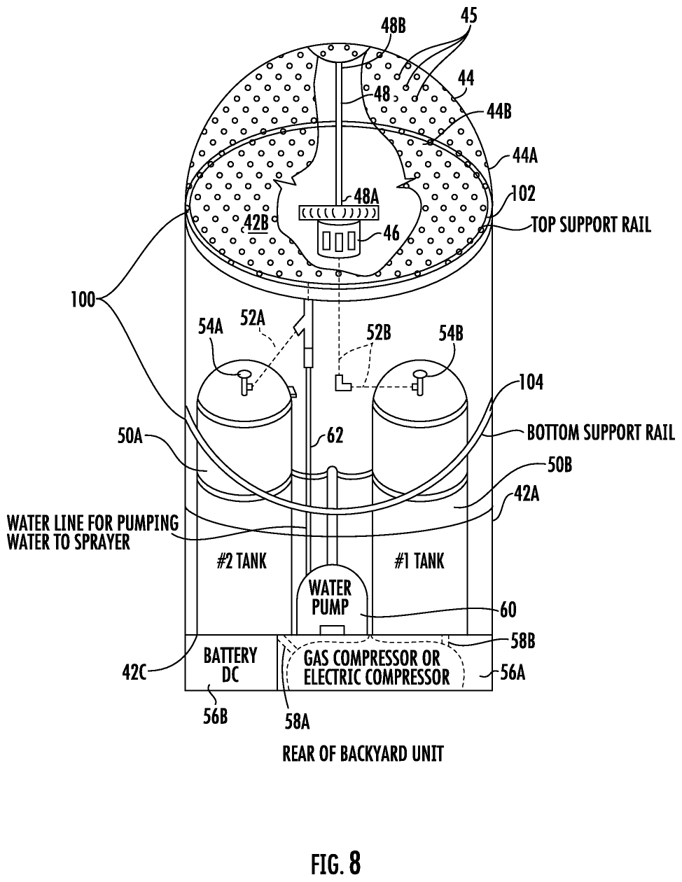

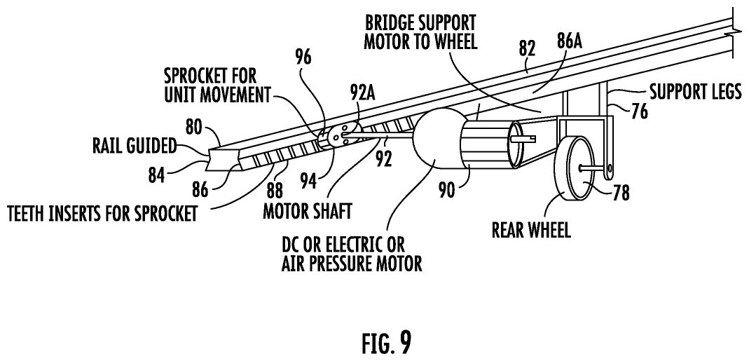

Referring to FIGS. 7-10, a rail mounted fire extinguishing apparatus system 40 for use to extinguish wildfires in populated areas is provided. The fire extinguishing apparatus system 40 can comprise a holding tank 42 having a cylindrical body 42A, a top 42B and a bottom 42C that defines a cavity 42D configured to hold water and one or more compressed air tanks 50A, 50B positioned within the cavity 42D of the holding tank 40 with each compressed air tank 50A, 50B having a conduit 52A, 52B passing from the corresponding tank 50A, 50B through the top 42B of the holding tank 42. The fire extinguishing apparatus system 40 can also comprise a valve 54A, 54B positioned on each conduit 52A, 52B within the holding tank 42 proximate to the top 42B of the holding tank 42. Additionally, the fire extinguishing apparatus system 40 can comprise a dispenser container 44 having body 44A having an inner cavity 44B that can be perforated to permit the distribution of water from the holding tank 42 therethrough. For example, the body 44A of the dispenser container 44 can have perforation holes 45. The dispenser container 44 can be rotatably attached to the holding tank 42, for example, to the top 42B and/or the top portion of the body 42A of the holding tank 42. The fire extinguishing apparatus system 40 can also comprise a pump 60 positioned at the bottom 42C of the holding tank 42. The pump 60 can have a pump conduit 62, such as a pipe or a hose, that extends from the pump 60 through the top 42B of the holding tank 42 to provide water to the cavity 44B of the dispenser container 44. In some embodiments, the pump conduit 62 can be extend through the top 42B of the holding tank 42 with the end of the pump conduit 62 being flush with a top surface of the top 42 of the of the holding tank 42. In some embodiments, the pump conduit 62 can be extend above the outer surface of the top 42 of the holding tank 42. The pump 60 can be used to pump water from the holding tank 42 into the inner cavity 44B of the dispenser container 44. In some embodiments, as shown in FIGS. 7 and 8, the air line 52A and the pump conduit 62 can merge to form an air/water supply conduit 52A/62 into the internal cavity 44B of the dispenser container 44.

The fire extinguishing apparatus system 40 can further comprise a pressure operated motor 46, such as a pneumatic motor, that can be secured to the top surface of the top 42B of the holding tank 42. The motor 46 can be connected to one of the conduits 52A, 52B of one of the air compressed tanks 50A, 50B to supply the motor 46 with pressurized air. For example, as shown in FIGS. 7-10, the motor 46 can be connected to the conduit 52B of the air compressed tanks 50B to supply the pressurized air that operates the motor 46. A shaft 48 can be rotatably secured to the motor 46 at a first end 48A and secured to a top portion of the body 44A of the dispenser container 44 at a second end 48B. As the motor 46 spins the shaft 48, the motor 46 can rotate the dispenser container 44 to dispense from inner cavity 44B in the body 44A of the dispenser container 44 water that is placed under high pressure from air provided by the compressed air tank 50A through the conduit 52A to the inner cavity 44B of the dispenser container 44. The air compressed tanks 50A, 50B can be stabilized within the holding tank 42 so that as the air compressed tanks 50A, 50B stay stable as the dispensing container spins or rotates. For example, stabilizer belts can be used to hold the air compressed tanks 50A, 50B in the place in the holding tank.

The fire extinguishing apparatus system 40 can additionally comprise a movable base 70 on which the holding tank 42 can be secured. The movable base 70 can comprise a base platform 72 on which the holding tank 42 can reside and a one or more glide support legs 74 extending downward on a first side 72A of the base platform 72 with each glide support leg 74 being attached to a glide 74A configured to engage a rail 80 that can extend beneath the movable base 70. The movable base 70 can also comprise one or more wheeled support legs 76 extending downward on a second side 72B with each wheeled support leg 76 being rotatably attached to a wheel 78. The rail 80 can have a top surface 82 and a beveled outer side 84 and grooved inner side 86. The glide 74A of the movable base 70 is configured to engage and can engage the top surface 82 and the bevel outer side 84. The grooved inner side 86 can comprise a groove 86A with sprocket receiving teeth 88 within the groove 86A for receiving a sprocket that aid in the moving of the movable base 70.

Further, the fire extinguishing apparatus system 40 can comprise a drive motor 90 secured underneath the movable base 70. The drive motor 90 can have a drive shaft 92 the extends outward perpendicular to the rail 80. The drive shaft 92 can have a sprocket 94 on an end 92A distal from the motor 90. The sprocket 94 can be configured to reside in the groove 86A in the inner grooved side 86 of the rail 80. The sprocket 94 can have sprocket teeth 96 as shown in FIG. 8 that engagement the sprocket receiving teeth 88 of the rail 80.

In some embodiments as shown, the fire extinguishing apparatus system 40 can comprise a smooth concrete strip 98 extending beneath the movable base 70 and aligned with the wheels 78 of the movable base 70. In some embodiments as shown, the fire extinguishing apparatus system 40 can comprise an air compressor 66A and power source 56B, such as a battery, that can be secure to the movable base 70. The air compressor 56A can have a plurality of air lines 58A, 58B that run from the air compress 56A to the compressed air tanks 50A, 50B that provide air from the air compressor 56A to the respective compressed air tanks 50A, 50B. The power source 56B can provide power to the air compressor 56A and/or other components, such as the drive motor 46 or the pump 60, of the fire extinguishing apparatus system 40 to provide power as needed or desired. In some embodiments as shown, the air compressor 56A and/or the power source 56B can be secured to the movable base 70 beneath the holding tank 42. In some embodiments, the air compressor 56A and/or the power source 56B can be secured to the movable base 70 at other locations and can have a combined housing or their own housing.

As with the fire extinguishing apparatus shown in FIGS. 1-5, to supply water to the holding tank 12, some embodiments of the fire extinguishing apparatus system 40 shown in FIGS. 7-10 can comprise a fire department access nozzle 47 that is configured to the holding tank 42. The fire department access nozzle 47 can be closed off with a cap that can be removed to allow a fire hose to screw onto or attach to the fire department access nozzle 47. Similarly, some embodiments of the fire extinguishing apparatus system 40 can comprise a valve 49 engaging the holding tank 42 for connecting a common water hose to provide water to the holding tank 42.

In some embodiments, the fire extinguishing apparatus system 40 can also comprise one or more spring loaded shock absorbers 36 that can be secured to a portion of the dispenser container 44 that does not rotate with the dispenser container 42 and the body of the holding tank 42.

To hold the dispenser container 44 to the holding tank 42, the dispenser container 44 can be secured to the holding tank 42 by an engagement 100. In some embodiments, the engagement 100 can comprise one or more support rails. In some embodiments, the engagement 100 can comprise at least one race and bearing assembly. The engagements 100, such as support rails or race and bearing assemblies can include rubber seals to improve water containment. For example, as shown in FIGS. 7-8 and 10 and as described above, the dispenser container 44 can be secured to the holding tank 42 by an engagement 100 comprising a first race and bearing assembly 102 and a second race and bearing assembly 104. The first race and bearing assembly 102 can comprise a first race 102A and a set of bearings 106 that can engage the first race 102A. The second race and bearing assembly 104 can comprise a second race 104A and a set of bearings 108 that can engage the second race 104A. The upper first race 102A and the lower second race 104A that are secured to the holding tank 42 and an upper set of bearings 106 secured to the dispenser container 44 that engage the upper first race 102A and a lower set of bearings 108 secured to the dispenser container 44 that engage the lower second race 104A. It is understood that the engagement 100 can comprise more than two race and bearing assemblies. The fire extinguishing apparatus system 40 can also comprise a seal mechanism 51, such as a rotatable annular rubber seal that can engage the dispenser container 44 and the top 42B of the holding tank 42 to seal the dispenser container 44 when water is provided from the holding tank 42 to the internal cavity 44B.

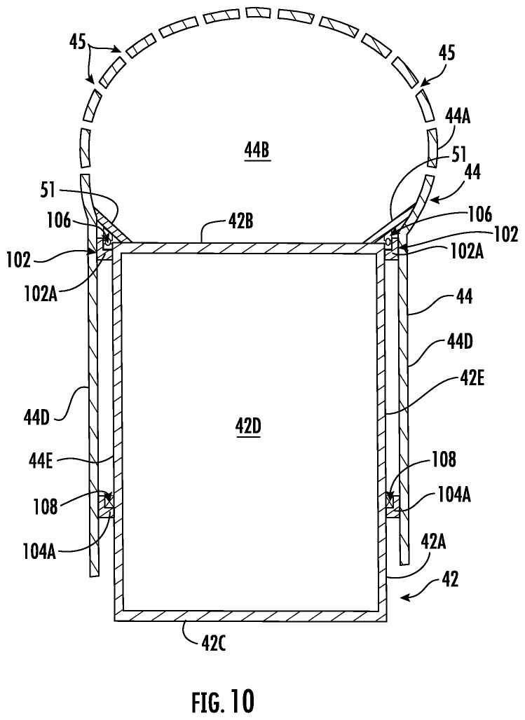

In particular, the body 42A of the holding tank 42 can comprise cylindrical side walls 42E between the bottom 42C and the top 42B of the holding tank 42 and the dispenser container 44 can comprise cylindrical side walls 44D that extend downward from a partial spherical body 44A as shown in FIG. 10, the holding tank cylindrical side walls 42E can form an inner shell having the upper first race 102A secured to the holding tank side walls 422E proximate the bottom 42B of the holding tank 42 and a lower second race 104A secured the holding tank side walls 42E near a distal end of the inner shell. Similarly, the dispenser container side walls 44D can form an outer shell that comprises bearings/bearing holders 106 108 secured thereto for engaging the upper first race 102A and the lower second race 104A respectively to form the engagement 100.

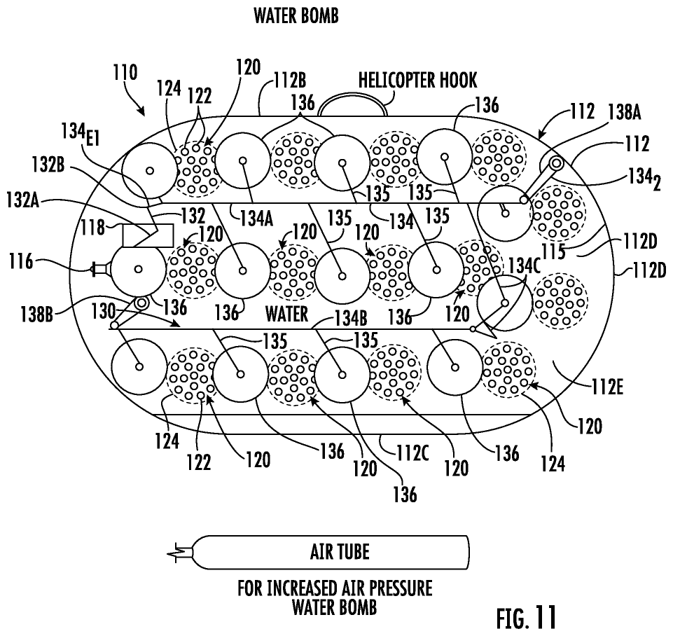

Referring to FIG. 11, a fire extinguishing apparatus 110 in the form of a pressurizable container, or water bomb, is provided that can be dropped by an aerial vehicle, such as a helicopter or an airplane to extinguish wildfires. The fire extinguishing apparatus 110 apparatus can comprise a holding tank 112 having a body 112A having a top 112B, bottom 112C and side walls 112D that define an internal cavity 112E configured to hold water. The side walls 112D can have a plurality of groupings 120 of spray holes 122 therein with each grouping 120 of spray holes 122 being in a geometric pattern 124. For example, the geometric patterns 124 of the groupings 120 of the spray holes 122 in the body 112A can be different geometric shapes. For instance, the geometric patterns 124 of the groupings 120 of the spray holes 122 in the body 112A can be circles, rectangles, squares, triangles, other polygonal two dimensional shapes, or the like. As shown, the geometric patterns 124 of the groupings 120 of the spray holes 122 in the body 112A are circles.

The fire extinguishing apparatus 110 that is configured to be dropped by an aerial vehicle to extinguish wildfires can comprise a capping shifter 130 configured to be movable from a closed position where the capping shifter 130 covers the geometric patterns 124 of the groupings 120 of the spray holes 122 to close the spray holes 122 to hold water in the holding tank 112 to an opened position where the first capping shifter 130 uncovers the spray holes 122 to disperse water from the holding tank 112. The fire extinguishing apparatus 110 can comprise at least one valve 116 in the body 112A of the holding tank 112 that permits the pumping of water and compressed air into the internal cavity 112E of the holding tank 112 when the first capping shifter 130 is in a closed position covering the groupings 120 of the spray holes 122. Additionally, or alternatively, one or more compressed air tanks can reside in the internal cavity 112E or be secured to another portion of the body 112A to supply compressed air to the internal cavity 112E. The fire extinguishing apparatus 110 can also comprise a controller 118 in communication with the capping shifter 130 to move the first capping shifter 130 to an open position to open the groupings 120 of the spray holes 122. The controller 118 can be, for example, a timer, solenoid valve, or a pressure sensitive valve.

To open and close the groupings 120 of the spray holes 122, the first capping shifter 130 can comprise a control arm 132 having a first end 132A pivotally connected at a pivot point to the controller 118 that can be secured to the interior surface 115 of the internal cavity 112E of the body 112A of the holding tank 112. The first capping shifter 130 can also comprise at least one shaft arm 134 that can be pivotally connected to a second end 132B of the control arm 132, such that as the control arm 132 is rotated about the pivot point in a first direction the at least one shaft arm 134 is moved linearly in a linear first direction and when the control arm 132 is rotated about the pivot point in a second direction the at least one shaft arm 134 is moved linearly in a linear second direction. Further, first capping shifter 130 can comprise cover pads 136 configured into a shape and corresponding in number to the geometric patterns 124 of the groupings 120 of spray holes 122 to allow the cover pads 136 to cover the corresponding geometric patterns 124 of the groupings 120 of spray holes 122. For example, the shapes of the cover pads 136 can be generally the same shape of the geometric patterns 124 of the groupings 120 of spray holes 122 with the cover pads 136 being large enough to cover and seal all the spray holes. The cover pads 136 can abut the interior surface 115 of the internal cavity 112E and can be movably connected to the at least one shaft arm 134 such that the cover pads 136 are movable from a closed position covering the geometric patterns 124 of the groupings 120 of the spray holes 122 to an open position where the groupings 120 of the spray holes 122 are uncovered. For example, each cover pad 136 can be connected to one of the shaft arms 134 by a cover pad support arm 135 as explained below.

The at least one shaft arm 134 can be rotatably connected on a first end 134_{E1} to the second end 132B of the control arm 132 and rotatably connected on a second end 134_{E2} to a guide arm 138A that is pivotally connected to the interior surface 115 of the internal cavity 112E of the body 112A of the holding tank 112 at a pivot point to aid in translating the rotational movement of the control arm 132 about the pivot point at the first end 132A of the control arm 132 into the linear movement of the shaft arm 134. Each of the cover pads 136 can be rigidly connected to the at least one shaft arm 134 by a cover support arm 135 that moves as the shaft arm 134 moves. Thus, as the at least one shaft arm 134 moves in a first direction, the cover support arms 135 move the cover pads 136 in the same direction to uncover the geometric patterns 124 of the groupings 120 of spray holes 122. As the at least one shaft arm 134 moves in an opposing second direction, the cover support arms 135 move the cover pads 136 in the same direction to cover the geometric patterns 124 of the groupings 120 of spray holes 122, closing the spray holes 122.

In some embodiments as shown, the at least one shaft arm 134 can comprise a first shaft arm 134A connected to a second shaft arm 134B that runs about parallel to the first shaft arm 134A by one or more linking arms 134C As above, the first shaft arm 134A can be movably connected on a first end 134_{E1} to the second end 132B of the control arm 132 and rotatably connected on a second end 134_{E2} to a guide arm 138A that is pivotally connected to the interior surface 115 of the internal cavity 112E of the body 112A of the holding tank 112 at a pivot point to aid in translating the rotational movement of the control arm 132 about the pivot point at the first end 132A of the control arm 132 into the linear movement of the first shaft arm 134A. The one or more linking arms 134C can be movably connected to the first shaft arm 134A and the second shaft arm 134B such that as the control arm moves the first shaft arm 134A, the one or more linking arms 134C is moved by the first shaft arm 134A which, in turn, moves the second shaft arm 134B. Similar to the first shaft arm 124A, the second shaft arm 134B can be the first shaft arm 134A can be movably connected to a guide arm 138B that is pivotally connected to the interior surface 115 of the internal cavity 112E of the body 112A of the holding tank 112 at a pivot point proximal to an opposing end of the second shaft arm 134B to which the second shaft arm 134B is connected to one of the one or more linking arms 134C to aid in linearly moving the second shaft arm 134B as the first shaft arm 134A moves. In some such embodiments, each of the cover pads 136 can be rigidly connected to at least one of the first shaft arm 134A, second shaft arm 134B or the one or more linking arms 134C by a cover support arm 135 that moves as the arm 134A, 134B, 134C moves.

Once the fire extinguishing apparatus 110 is filled with fire extinguishing liquid, such as water, and compressed air through valve 116. the fire extinguishing apparatus 110 can be loaded on an aerial vehicle and dropped into wildfires. For example, the cover pads can be operated by remote control after the fire extinguishing apparatus 110 is dropped to release the fire extinguishing liquid.

Thus, as provided above, methods are provided for using and operating rail mounted fire extinguishing apparatuses as shown in FIGS. 7-10 and fire extinguishing apparatus 110 as shown in FIG. 11 that can be dropped from an aerial vehicle. Further, methods are provided for using and operating fire extinguishing apparatuses shown in FIGS. 1A-6. For example, a method of using a fire extinguishing apparatus suspended from a helicopter to extinguish wildfires is disclosed herein. A fire extinguishing apparatus as disclosed above is provided. The fire extinguishing apparatus can comprise a holding tank as described above having a cylindrical body, a top and a bottom that defines a cavity configured to hold water and a plurality of compressed air tanks positioned within the cavity of the holding tank with each compressed air tank having a conduit passing from the corresponding compressed air tank through the bottom of the holding tank. A valve can be positioned on each conduit within the holding tank proximate to the bottom of the holding tank. The fire extinguishing apparatus can also comprise a dispenser container as described above rotatably attached the holding tank. The dispenser container can comprise a body having walls with at least a section of the walls including a bottom portion being perforated. Additionally, the fire extinguishing apparatus can comprise a motor as described above secured to the holding tank and engaging the dispenser container to rotate the dispenser container to dispense water from the dispenser container. The method can include securing the fire extinguishing apparatus to a helicopter and operating the first extinguishing apparatus to dispense fire extinguishing liquid onto a fire from the helicopter as described above. For example, the step of securing the fire extinguishing apparatus to a helicopter comprises securing the fire extinguishing apparatus to an undercarriage of the helicopter with hanging lines. A fire extinguishing liquid can be placed into the holding tank as described above, for example, by filing the holding tank with water through a water hose valve or a fire department hose access so that the liquid is available to be dispersed from the dispenser container. The method can also comprise transferring the fire extinguishing liquid from the holding tank to the dispenser container as described above to disperse the fire extinguishing liquid from the dispenser container. Other methods and more detailed steps are disclosed in or apparent from the disclosure above.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole and in part. Furthermore, those of ordinary skill in the art will appreciate that the foregoing description is by way of example only, and is not intended to limit the present subject matter.

What is claimed is:

1. A fire extinguishing apparatus for use with a helicopter to extinguish wildfires, the fire extinguishing apparatus comprising:
a holding tank having a cylindrical body, a top and a bottom that defines a cavity configured to hold water;
a plurality of compressed air tanks positioned within the cavity of the holding tank with each compressed air tank having a conduit passing from the corresponding compressed air tank through the bottom of the holding tank;
a valve positioned on each conduit within the holding tank proximate to the bottom of the holding tank;
a dispenser container rotatably attached the holding tank, the dispenser container comprising a body having walls with at least a section of the walls including a bottom portion being perforated;
a pressure operated motor secured to an under surface of the bottom of the holding tank, the motor connected to the conduit of one of the compressed air tanks to supply the motor with pressurized air;
a shaft having a first end and a second end, the shaft rotatably secured to the motor at the first end of the shaft and secured to the bottom portion of the dispenser container at the second end of the shaft, so that, as the motor spins the shaft, the motor rotates the dispenser container to dispense water from the dispenser container.

2. The fire extinguishing apparatus according to claim 1, further comprising an air compressor secured to the holding tank, the air compressor having a plurality of air lines that provide air from the air compressor to the respective compressed air tanks.

3. The fire extinguishing apparatus according to claim 2, wherein the air compressor is secured to the top of the holding tank.

4. The fire extinguishing apparatus according to claim 1, further comprising a fire department access nozzle configured to the holding tank, the fire department access nozzle configured for attachment of a fire hose coupling.

5. The fire extinguishing apparatus according to claim 1, further comprising a valve engaging the holding tank for connecting a water hose to provide water to the holding tank.

6. The fire extinguishing apparatus according to claim 1, further comprising a rudder secured to the side of the holding tank to steady the holding tank upon operation of the motor to spin the dispenser container.

7. The fire extinguishing apparatus according to claim 1, wherein the dispenser container is secured to the holding tank by an engagement comprising at least one race and bearing assembly.

8. The fire extinguishing apparatus according to claim 7, wherein the holding tank comprises cylindrical side walls that extend down from the bottom of the holding tank and the dispenser container comprises cylindrical side wails that extend upward from a cylindrical body, the holding tank cylindrical side walls forming an outer shell having an upper race secured thereto proximate the bottom of the holding tank and a lower race secure to the holding tank side wall near a distal end of the outer shell and the dispenser container side walls forming an inner shell that comprises bearings secured thereto for engaging the upper race and the lower race respectively to form the engagement.

9. The fire extinguishing apparatus according to claim 1, wherein the body of the dispenser container comprises a cylindrical body and a bottom, the cylindrical body and the bottom being perforated.

10. The fire extinguishing apparatus according to claim 1, wherein the body of the dispenser container comprises a partial spherical body portion that forms a bottom of the dispenser container, the partial spherical body portion being perforated.

11. The fire extinguishing apparatus according to claim 10, wherein the holding tank has an opening therein with a door that opens and closes to allow water to transfer from the holding tank to the dispenser container.

12. The fire extinguishing apparatus according to claim 1, further comprising one or more spring loaded shock absorbers secured to the body of the dispenser container.

13. A rail mounted fire extinguishing apparatus system for use to extinguish wildfires in populated areas, the fire extinguishing apparatus comprising:
a holding tank having a cylindrical body, a top and a bottom that defines a cavity configured to hold water;
a plurality of compressed air tanks positioned within the cavity of the holding tank with each compressed air tank having a conduit passing from the corresponding compressed air tank through the top of the holding tank;
a valve positioned on each conduit within the holding tank proximate to the top of the holding tank;
a dispenser container having a partial spherical body, the dispenser container rotatably attached the top of the holding tank, the partial spherical body being perforated;
a pump positioned at the bottom of the holding tank to provide water to the cavity of the dispenser container;
a pressure operated motor secured to a top surface of the top of the holding tank, the motor connected to one of the conduits of one of the air compressed tanks to supply the motor with pressurized air;
a shaft having a first end and a second end, the shaft rotatably secured to the motor at the first end of the shaft and secured to the bottom portion of the dispenser container at the second end of the shaft, so that, as the motor spins the shaft, the motor rotates the dispenser container to dispense water that is placed under pressure from the dispenser container;
a movable base on which the holding tank is secured, the movable base comprising a base platform on which the holding tank resides and a one or more glide support legs extending downward on a first side with one or more glide support legs being attached to a glide configured to engage a rail and one or more wheeled support legs extending downward on a second side with each wheeled support leg being attached to a rotatable wheel;
a rail extending beneath the movable base, the rail having a top surface and a beveled outer side and grooved inner side, the grooved inner side comprising sprocket receiving teeth while the glide of the movable base being configured to engage the top surface and bevel outer side;
a drive motor secured underneath the movable base, the drive motor having a drive shaft the extends outward perpendicular to the rail, the drive shaft having a sprocket on an end distal from the motor with the sprocket residing in the groove in the inner side of the rail having sprocket teeth that engagement the sprocket receiving teeth of the rail.

14. The fire extinguishing apparatus system according to claim 13, further comprising a smooth concrete strip extending beneath the movable base and aligned with the wheels of the movable base.

15. The fire extinguishing apparatus system according to claim 13, further comprising an air compressor and power source secure to the movable base, the air compressor having plurality of air lines that provide air from the air compressor to the respective compressed air tanks.

16. The fire extinguishing apparatus system according to claim 15, wherein the air compressor is secured to the movable base beneath the holding tank.

17. The fire extinguishing apparatus system according to claim 13, further comprising a fire department access nozzle configured to the holding tank, the fire department access nozzle configured for attachment of a fire hose coupling.

18. The fire extinguishing apparatus system according to claim 13, further comprising a valve engaging the holding tank for connecting a water hose to provide water to the holding tank.

19. The fire extinguishing apparatus system according to claim 13, further comprising one or more spring loaded shock absorbers secured to the body of the dispenser container.

20. The fire extinguishing apparatus according to claim 13, wherein the dispenser container is secured to the holding tank by an engagement comprising at least one race and bearing assembly.

21. The fire extinguishing apparatus according to claim 20. wherein the body of the holding tank comprises cylindrical side walls between the bottom and the top of the holding tank and the dispenser container comprises cylindrical side walls that extend downward from the cylindrical body, the holding tank cylindrical side walls forming an inner shell having an upper race secured to the holding tank side walls proximate the bottom of the holding tank and a lower race secure the holding tank side walls near a distal end of the outer shell and the dispenser container side walls forming an outer shell that comprises bearings secured thereto for engaging the upper race and the lower race respectively to form the engagement.

22. A fire extinguishing apparatus configured to be dropped from an aerial vehicle to extinguish wildfires, the fire extinguishing apparatus comprising:
a holding tank having a body having a top, bottom and side walls that defines an internal cavity configured to hold water, the side walls having a plurality of groupings of spray holes therein with each grouping of spray holes being in a geometric pattern;
a first capping shifter configured to be movable from a closed position where the first capping shifter covers the geometric patterns of the groupings of the spray holes to close the spray holes to hold water in the holding tank to an opened position where the first capping shifter uncovers the spray holes to disperse water from the holding tank;
at least one valve in the body of the holding tank that permits the pumping of water and compressed air into the internal cavity of the holding tank when the first capping shifter is in a closed position covering the groupings of the spray holes; and
a control in communication with the capping shifter to move the first capping shifter to an open position to open the groupings of the spray holes.

23. The fire extinguishing apparatus according to claim 22, wherein the geometric patterns of the groupings of the spray holes in the body are circles.

24. The fire extinguishing apparatus according to claim 22, wherein the first capping shifter comprises:
a control arm pivotally connected at a pivot point to the controller that is secured to the interior surface of the internal cavity of the body of the holding tank;
at least one shaft arm rotatably connected to the control arm, such that as the control arm is rotated about the pivot point in a first direction the at least one shaft arm is moved linearly in a linear first direction and when the control arm is rotated about the pivot point in a second direction the at least one shaft arm is moved linearly in a linear second direction; and
cover pads configured into the same shape of and corresponding in number to the geometric patterns of the groupings of spray holes, the cover pads abutting the interior surface of the internal cavity and being movably connected to the at least one shaft arm such that the cover pads are movable from a closed position covering the geometric patterns of the groupings of the spray holes to an open position where the groupings of the spray holes are uncovered.

25. The fire extinguishing apparatus according to claim 24, wherein the at least one shaft arm is rotatably connected on a first end to the control arm and rotatably connected on a second end to a guide arm that is pivotally connected to the interior surface of the internal cavity of the body of the holding tank at a pivot point to translate the rotational movement of the control arm into the linear movement of the shaft arm.

26. The fire extinguishing apparatus according to claim 24, wherein each of the cover pads are rigidly connected to the at least one shaft arm by a cover support arm that moves as the shaft arm moves.

27. The fire extinguishing apparatus according to claim 24, wherein the at least one shaft arm comprises a first shaft arm connected to a second shaft arm that runs about parallel to the first shaft arm by one or more linking arms.

28. The fire extinguishing apparatus according to claim 27, wherein each of the cover pads are rigidly connected to at least one of the first shaft arm, second shaft arm or the one or more linking arms by a cover support arm that moves as the shaft arm moves.

29. A method of using a fire extinguishing apparatus suspended from a helicopter to extinguish wildfires, the method comprising:
providing a fire extinguishing apparatus comprising:
a holding tank having a cylindrical body, a top and a bottom that defines a cavity configured to hold water;
a plurality of compressed air tanks positioned within the cavity of the holding tank with each compressed air tank having a conduit passing from the corresponding compressed air tank through the bottom of the holding tank;
a valve positioned on each conduit within the holding tank proximate to the bottom of the holding tank;
a dispenser container rotatably attached the holding tank, the dispenser container comprising a body having walls with at least a section of the walls including a bottom portion being perforated;
a motor secured to the holding tank and engaging the dispenser container to rotate the dispenser container to dispense water from the dispenser container
securing the fire extinguishing apparatus to a helicopter; and
operating the first extinguishing apparatus to dispense Fire extinguishing liquid onto a fire from the helicopter.

30. The method according to claim 29, wherein the motor of the fire extinguishing apparatus comprises a pressure operated motor secured to an under surface of the bottom of the holding tank, the motor connected to the conduit of one of the compressed air tanks to supply the motor with pressurized air, and the fire extinguishing apparatus further comprises a shaft having a first end and a second end, the shaft rotatably secured to the motor at the first end of the shaft and secured to the bottom portion of the dispenser container at the second end of the shaft, so that, as the motor spins the shaft, the motor rotates the dispenser container to dispense water from the dispenser container.

31. The method according to claim 29, wherein the step of securing the fire extinguishing apparatus to a helicopter comprises securing the fire extinguishing apparatus to an undercarriage of the helicopter with hanging lines.

32. The method according to claim 29, further comprising placing a fire extinguishing liquid into the holding tank to be dispersed from the dispenser container.

33. The method according to claim 32, further comprising transferring the fire extinguishing liquid from the holding tank to the dispenser container to disperse the fire extinguishing liquid from the dispenser container.
